(19) United States
(12) Patent Application Publication
(10) Pub. No.: US 2010/0213651 A1
(43) Pub. Date: Aug. 26, 2010

(54) Fluid-filled cylindrical vibration-damping device

(75) Inventors: Hiroaki Hori, Inuyama-shi (JP); Eiji Tanaka, Komaki-shi (JP)

Correspondence Address: OLIFF & BERRIDGE, PLC, P.O. BOX 320850, ALEXANDRIA, VA, 22320-4850, US

(73) Assignee: TOKAI RUBBER INDUSTRIES, LTD., KOMAKI-SHI (JP)

(21) Appl. No.: 12/654,148

(22) Filed: Dec. 11, 2009

(30) Foreign Application Priority Data
Feb. 26, 2009 (JP) 2009-044129

(51) Int. Cl. F16F 13/06

(52) U.S. Cl. 267/140.13

(57) ABSTRACT

A fluid-filled cylindrical vibration-damping device including a rubber elastic body elastically interconnecting an inner shaft member and an intermediate sleeve, having a first pocket and a second pocket closed by an outer tube member thereby defining a pressure receiving chamber and an equilibrium chamber respectively. Annular sealing portions are provided at axially opposite ends between the intermediate sleeve and the outer tube member. A circumferential groove extends in a circumferential direction between an axial edge of the second pocket and the annular sealing portion in an axial direction, being closed by the outer tube member to provide an orifice passage. One end of the orifice passage circumferentially opens to the pressure receiving chamber while another end circumferentially opens to the equilibrium chamber such that an axial inside dimension of the second pocket is expanded compared to that of an orifice-passage-formation part at a side of opening of the orifice passage.

### INCORPORATED BY REFERENCE

The disclosure of Japanese Patent Application No. 2009-044129 filed on Feb. 26, 2009 including the specification, drawings and abstract is incorporated herein by reference in its entirety.

### BACKGROUND OF THE INVENTION

1. Field of the Invention

The present invention relates to a fluid-filled cylindrical vibration-damping device adapted for use, for example, as an automotive engine mount.

2. Description of the Related Art

Cylindrical vibration-damping devices have been used as one known class of vibration damping devices for interposition between components that make up a vibration transmission system in order to provide vibration damped linkage to the components. The cylindrical vibration-damping devices have a construction in which an inner shaft fitting adapted to be attached to one component of the vibration transmission system and an outer tube fitting adapted to be attached to the other component are elastically connected with each other by a main rubber elastic body.

Various fluid-filled cylindrical vibration-damping devices have been proposed in an effort to mainly improve vibration damping characteristics thereof. Examples of such designs include the device disclosed in Japanese Examined Utility Model Publication No. JP-Y-6-25732 which exhibits excellent vibration damping effect utilizing resonance action etc. of non-compressible fluid filled in the interior. More specifically, for example, fluid-filled cylindrical vibration-damping devices include: an inner shaft fitting; an outer tube fitting; a pressure receiving chamber whose wall is partially defined by a main rubber elastic body and an equilibrium chamber whose wall is partially defined by a diaphragm that are formed diametrically between two fittings; and an orifice passage that connects the pressure receiving chamber with the equilibrium chamber.

However, fluid-filled cylindrical vibration-damping devices of conventional construction such as disclosed in JP-Y-6-25732 have difficulty in providing a sufficient passage length of the orifice passage and tuning the orifice passage to low frequency was therefore difficult. Specifically, since the orifice passage is formed so as to extend in the circumferential direction between the pressure receiving chamber and the equilibrium chamber, a sufficient passage length of the orifice passage would not be obtained without reducing the circumferential dimensions of the pressure receiving chamber and the equilibrium chamber. Consequently, vibration damping capabilities will be diminished due to lack of volume of these chambers.

As one method of ensuring a sufficient passage length of the orifice passage, there has also been proposed a construction which includes a separate orifice forming member, as disclosed in Japanese Unexamined Patent Publication No. JP-A-2004-218683. This makes it possible to form an orifice passage with the orifice forming member so as to straddle the pressure receiving chamber and the equilibrium chamber in the circumferential direction, thereby readily ensuring a passage length of the orifice passage. However, the need of the separate member for forming an orifice passage results in problems such as increased number of manufacturing processes due to the increased number of components, or complicated construction of the device.

Meanwhile, U.S. Pat. No. 5,199,691 discloses a construction in which an orifice passage is formed so as to extend in the circumferential direction at the locations axially outside of the pressure receiving chamber and the equilibrium chamber. However, this construction poses another problem that a space for forming an orifice passage will be required at axially outside of the chambers, causing an increased axial dimension of the fluid-filled cylindrical vibration-damping device. On the other hand, if the construction disclosed in U.S. Pat. No. 5,199,691 is applied to the device without increasing the axial dimension of the device, reducing the axial dimension of each of the pressure receiving chamber and the equilibrium chamber will be necessary. This will cause a reduced effective piston surface area of the pressure receiving chamber as well as deterioration of volume compensation action of the equilibrium chamber, making it difficult to exhibit an intended vibration damping capabilities.

### SUMMARY OF THE INVENTION

It is therefore one object of the present invention to provide a fluid-filled cylindrical vibration-damping device of novel structure, that is able to effectively exhibit vibration damping effect based on the flow action of the fluid through the orifice passage and is realized in a compact design with a smaller number of parts.

The above and/or optional objects of this invention may be attained according to at least one of the following modes of the invention. The following modes and/or elements employed in each mode of the invention may be adopted at any possible optional combinations. It is to be understood that the principle of the invention is not limited to these modes of the invention and combinations of the technical features, but may otherwise be recognized based on the teachings of the present invention disclosed in the entire specification and drawings or that may be recognized by those skilled in the art in the light of the present disclosure in its entirety.

Specifically, the present invention provides a fluid-filled cylindrical vibration-damping device including: an inner shaft member; a tubular intermediate sleeve disposed outward of the inner shaft member with a gap therebetween, and having a first window and at least one second window; a rubber elastic body elastically connecting the inner shaft member and the intermediate sleeve, the rubber elastic body includes a first pocket and a second pocket provided at respective circumferential portions thereof while opening in an outer circumferential surface of the intermediate sleeve through the first and second windows of the intermediate sleeve, the rubber elastic body being provided with a slit so that a bottom portion of the second pocket is defined as at least one flexible film; an outer tube member outwardly fitted onto the intermediate sleeve in order to close an opening of the first pocket and define a pressure receiving chamber whose wall is partially defined by the rubber elastic body and filled with a non-compressible fluid, and in order to close an opening of the second pocket and define an equilibrium chamber whose wall is partially defined by the flexible film and filled with the non-compressible fluid; and an orifice passage permitting a fluid communication between the pressure receiving chamber and the equilibrium chamber, wherein annular sealing portions are provided at axially opposite end portions between the intermediate sleeve and the outer tube member over entire circumferences thereof, a circumferential groove is provided so as to extend in a circumferential direction between at least one of axially opposite edge portions of the second pocket and the annular sealing portion or portions that are opposed in an axial direction to the at least one of axially opposite edge portions of the second pocket, the circumferential groove is closed by means of the outer tube member to provide the orifice passage, one of opposite ends of the orifice passage opens to the pressure receiving chamber in the circumferential direction, and another of opposite ends of the orifice passage opens to the equilibrium chamber in the circumferential direction such that an axial inside dimension of the second pocket that defines the equilibrium chamber is expanded in comparison with that of an orifice-passage-formation-part at a side of opening of the orifice passage.

With the fluid-filled cylindrical vibration-damping device of construction according to the present invention, since the equilibrium chamber is expanded in the axial direction at the portion which connects with the orifice passage, wall spring rigidity will become lower, whereby changes in volume can readily arise. With this arrangement, the initial pressure acting on the equilibrium chamber due to the flow action of the fluid through the orifice passage will be rapidly absorbed by volume compensation action of the expanded portion. Accordingly, the flow action of the fluid through the orifice passage will effectively arise thereby exhibiting an intended vibration damping effect.

Moreover, as the amount of fluid flow through the orifice passage increases, the entire equilibrium chamber that includes not only the expanded portion but also the orifice-passage-formation part away from the expanded portion will exhibit fluid pressure compensation action on the pressure receiving chamber. This exhibits excellent vibration damping effect.

In addition, in the equilibrium chamber, the orifice passage is formed at least one of the axially opposite edge portions of the section away from the expanded portion. With this arrangement, it is possible to establish a sufficient passage length of the orifice passage, whereby the orifice passage will advantageously obtain the degree of freedom in tuning and the degree of freedom of design. Furthermore, the orifice passage is formed at the location axially inside of the annular sealing portions, thereby preventing the increased axial dimension of the fluid-filled cylindrical vibration-damping device.

Also, since the opposite end portions of the orifice passage both open to the pressure receiving chamber and the equilibrium chamber in the circumferential direction, the fluid induced to flow through the orifice passage in the circumferential direction will smoothly flow in and out of the two chambers. This arrangement permits an efficient fluid flow between the pressure receiving chamber and the equilibrium chamber, whereby excellent vibration damping capabilities will be attained.

Furthermore, there is no need of the separate member for forming the orifice passage. Therefore, the reduction of the number of components and the attachment processes will be realized.

In yet preferred form of the fluid-filled cylindrical vibration-damping device of construction according to the present invention, the second window of the intermediate sleeve has an axial dimension corresponding to that of an expanded portion of the second pocket over an entire circumferential length thereof, and a part of the second pocket where the circumferential groove is defined is integrally formed with the rubber elastic body, and projects axially inwardly from the one of axially opposite edge portions of the second window.

With the fluid-filled cylindrical vibration-damping device of construction according to the present mode, with respect to the intermediate sleeve it is possible to employ a shape that obviates the need of specifying top/bottom thereof. Accordingly, while setting the intermediate sleeve with respect to the mold for vulcanization molding of the rubber elastic body, occurrence of defective products due to an error in setting orientation of the intermediate sleeve will be avoided.

Moreover, since the orifice-passage-formation part provided at at least one of the axially opposite edge portions of the second pocket is integrally formed with the rubber elastic body, the number of components will be reduced.

In yet preferred form of the fluid-filled cylindrical vibration-damping device of construction according to the present invention, the second pocket includes a first bag-shaped portion and a second bag-shaped portion, which are spaced away from each other in the circumferential direction, wherein the at least one flexible film comprises a first flexible film and a second flexible film which partially define the first bag-shaped portion and the second bag-shaped portion respectively, wherein a communicating groove is provided for connecting the first and second bag-shaped portions, wherein an axially inside dimension of the first bag-shaped portion is expanded in comparison with that of the second bag-shaped portion at least one of axially opposite sides to provide the orifice passage between the one of axially opposite edge portions of the second bag-shaped portion and the annular sealing portion in the axial direction, and wherein the other one of the opposite ends of the orifice passage is connected to the equilibrium chamber at a portion composed of the first bag-shaped portion.

With the fluid-filled cylindrical vibration-damping device of construction according to the present mode, the axially inside dimension of the first bag-shaped portion is expanded, whereby the first bag-shaped portion will effectively exhibit volume compensation action on the pressure receiving chamber. Consequently, the orifice passage is connected with the first bag-shaped portion, so that the fluid pressure exerted on the equilibrium chamber during the initial fluid flow through the orifice passage will be effectively absorbed by the volume compensation action on the pressure receiving chamber exhibited by the first bag-shaped portion.

Furthermore, the second bag-shaped portion is connected with the first bag-shaped portion, whereby the equilibrium chamber is constructed with a sufficient volume as a whole. Accordingly, even if the amount of fluid flow through the orifice passage increases, the volume compensation action on the pressure receiving chamber will be effectively exhibited by the entire equilibrium chamber.

### BRIEF DESCRIPTION OF THE DRAWINGS

The foregoing and/or other objects, features and advantages of the invention will become more apparent from the following description of a preferred embodiment with reference to the accompanying drawings in which like reference numerals designate like elements and wherein:

FIG. 1 is an elevational view in axial or vertical cross section of a fluid-filled cylindrical vibration-damping device in the form of an automotive engine mount, which is constructed according to a first embodiment of the invention, taken along line 1-1 of FIG. 2;

FIG. 2 is a cross sectional view taken along line 2-2 of FIG. 1;

FIG. 3 is a side elevational view of an intermediate sleeve of the engine mount of FIG. 1;

FIG. 4 is a rear elevational view of the intermediate sleeve of FIG. 3;

FIG. 5 is a side elevational view of an integrally vulcanization molded component of the engine mount of FIG. 1;

FIG. 6 is a rear elevational view of the integrally vulcanization molded component of FIG. 5;

FIG. 7 is a front elevational view of the integrally vulcanization molded component of FIG. 5;

FIG. 8 is a cross sectional view taken along line 8-8 of FIG. 5; and

FIG. 9 is a cross sectional view taken along line 9-9 of FIG. 5.

### DETAILED DESCRIPTION OF PREFERRED EMBODIMENTS

A more specific understanding of the invention will be provided through the following detailed description of the embodiments of the present invention, made with reference to the accompanying drawings.

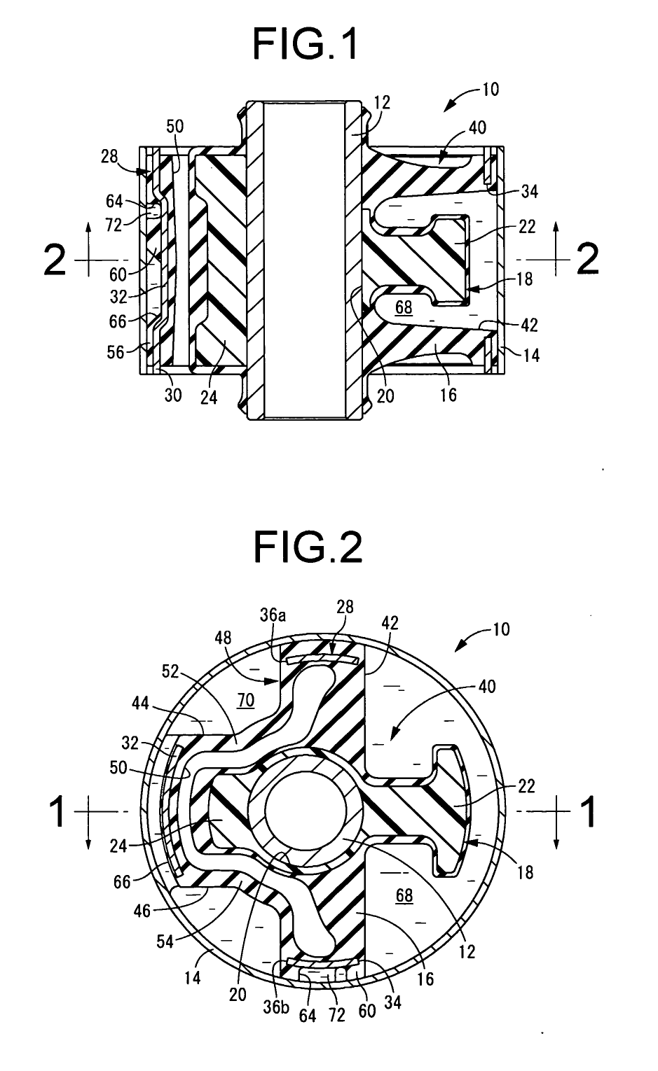

Referring first to FIGS. 1 and 2, there is depicted an automotive engine mount 10 as a first embodiment of the fluid-filled cylindrical vibration-damping device of construction according to the present invention. The engine mount 10 has a construction in which an inner shaft member 12 of metal and an outer tube member 14 of metal are connected to one another by a rubber elastic body 16. The inner shaft member 12 is then mounted onto the power unit side (not shown) while the outer tube member 14 is mounted onto the vehicle body side (not shown) so as to provide vibration damped linkage of the power unit to the vehicle body. In the description hereinbelow, the vertical direction refers to the vertical direction in FIG. 1 as a general rule, which coincides with the axial direction.

To describe in greater detail, the inner shaft member 12 is a high-rigidity member made of metal such as iron or aluminum alloy and has a small-diameter, generally round tube shape that extends straight. A stopper member 18 is attached to the inner shaft member 12. The stopper member 18 is of generally block shape overall and has a mounting hole 20 that pierces the center section thereof in the axial direction, into which the inner shaft member 12 is inserted. The stopper member 18 includes a first stopper portion 22 that projects out towards one diametrical side of the inner shaft member 12 and a second stopper portion 24 that projects out towards the other diametrical side of the inner shaft member 12. The projecting distal end of the first stopper portion 22 has a plate shape that extends in the direction approximately orthogonal to the projecting direction, with its surface situated on the projecting distal end side having a curving surface that corresponds to the inside peripheral face of the outer tube member 14 described later, thereby ensuring a sufficient abutting surface area against the outer tube member 14.

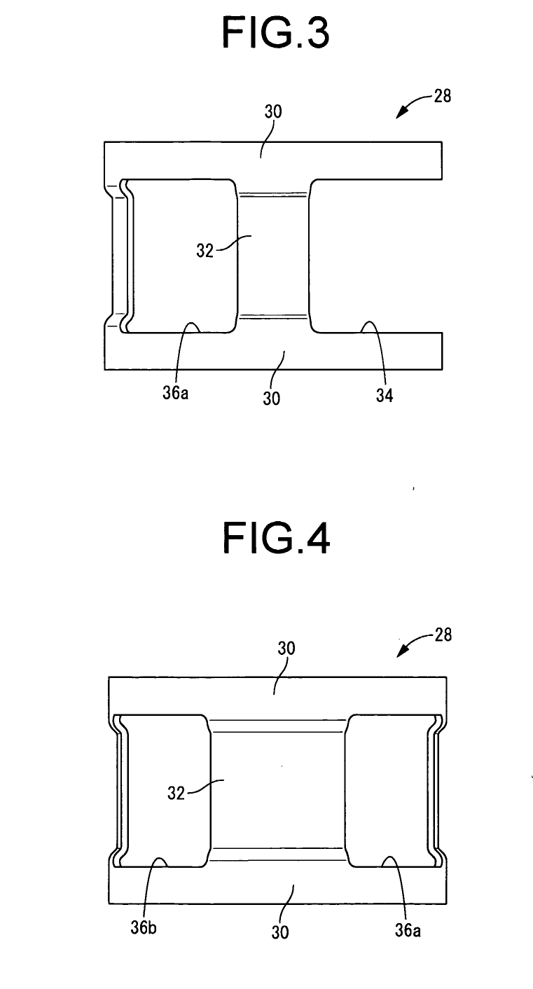

An intermediate sleeve 28 depicted in FIGS. 3 and 4 is disposed outward of the inner shaft member 12. The intermediate sleeve 28 is formed of metal similar to the inner shaft member 12 and has a thin, large-diameter, generally round tube shape. The intermediate sleeve 28 includes axially opposite end portions that define a large-diameter tubular portion 30 and an axially medial portion that defines a small-diameter tubular portion 32 so as to provide constricted contours overall.

The intermediate sleeve 28 further includes a first window 34 and a pair of second windows 36a, 36b. The first and second windows 34 and 36a, 36b are formed so as to penetrate the intermediate sleeve 28 in the diametrical direction and are circumferentially spaced apart from one another with respective prescribed circumferential lengths. In the present embodiment, the first window 34 has a length just short of halfway around the circumference while the pair of the second windows 36a, 36b each have a length just short of one-fourth of the circumference so as to have an circumferentially inside dimension smaller than that of the first window 34. In addition, in the present embodiment, the first window 34 and the second windows 36a, 36b each have an axially inside dimension substantially unchanging across the entire length in the circumferential direction and substantially equal to one another. Moreover, as depicted in FIG. 4, in the intermediate sleeve 28 according to the present embodiment, the pair of the second windows 36a, 36b are generally identical with each other in shape whereby the intermediate sleeve 28 has a symmetrical construction with respect to a plane that extends in the axially central portion thereof. In other words, the intermediate sleeve 28 will be identical in shape when vertically inverted.

The inner shaft member 12 and the intermediate sleeve 28 are arranged in a concentric fashion with a diametrical spacing therebetween and connected with each other by the rubber elastic body 16. The rubber elastic body 16 has a thick-walled, generally round tube shape overall and is arranged with its inside peripheral face bonded by vulcanization to the outside peripheral face of the inner shaft member 12 while with its outside peripheral face bonded by vulcanization to the inside peripheral face of the intermediate sleeve 28. With this arrangement, the rubber elastic body 16 takes the form of an integrally vulcanization molded component 40 incorporating the inner shaft member 12 and the intermediate sleeve 28. In the present embodiment, the intermediate sleeve 28 employs a construction that can be set with respect to the mold for vulcanization molding of the rubber elastic body 16 without the need of specifying top/bottom thereof. Furthermore, in the present embodiment, the entire surface of the stopper member 18 that is attached to the inner shaft member 12 is covered by a rubber layer integrally formed with the rubber elastic body 16.

The rubber elastic body 16 includes a first pocket 42 in the axially medial portion thereof. The first pocket 42 has a recessed shape that opens in the outer circumferential surface of the rubber elastic body 16 with a circumferential length just short of halfway around the circumference. This first pocket 42 further opens in the outer circumferential surface of the intermediate sleeve 28 through the first window 34 formed therein.

Meanwhile, the rubber elastic body 16 includes a first bag-shaped portion 44 and a second bag-shaped portion 46. Like the first pocket 42, the first and second bag-shaped portions 44, 46 are formed in the axially medial portion of the rubber elastic body 16 and have a recessed shape that opens in the outer circumferential surface thereof. The circumferential dimension of each of the first and second bag-shaped portions 44, 46 is just short of one-fourth of the circumference. The first bag-shaped portion 44 opens in the outer circumferential surface of the intermediate sleeve 28 through the second window 36a formed therein while the second bag-shaped portion 46 opens in the outer circumferential surface of the intermediate sleeve 28 through the second window 36b formed therein. Moreover, the first and second bag-shaped portions 44, 46 are circumferentially connected with each other via the section located between the pair of the second windows 36a, 36b (a communicating groove 66 described later) in the small-diameter tubular portion 32 of the intermediate sleeve 28. In this way, a second pocket 48 according to the present embodiment is provided including the first and second bag-shaped portions 44, 46. The first pocket 42 and the second pocket 48 are provided with a prescribed separation distance in the circumferential direction while the first bag-shaped portion 44 and the second bag-shaped portion 46 are formed being separated from each other in the circumferential direction.

As depicted in FIG. 2, a slit 50 is provided in the rubber elastic body 16 so as to bore in the axial direction between the diametrically opposed inner shaft member 12 and intermediate sleeve 28. The slit 50 is formed so as to encircle approximately halfway about the outer circumference of the inner shaft member 12 and the two circumferential ends of the slit 50 extend towards diametrically outward in the present embodiment. The slit 50 is located on the opposite side of the first window 34 of the intermediate sleeve 28 with the inner shaft member 12 being interposed therebetween so that the second stopper portion 24 is situated in opposition to the intermediate sleeve 28 with the slit 50 being interposed therebetween.

Since the slit 50 is formed in the rubber elastic body 16, the rubber elastic body 16 has thin portions that constitute the bottom portions (inside peripheral walls) of the first and second bag-shaped portions 44, 46. By utilizing these thin portions, a first flexible film 52 that partially defines the wall of the first bag-shaped portion 44 and a second flexible film 54 that partially defines the wall of the second bag-shaped portion 46 are integrally formed with the rubber elastic body 16. In the present embodiment, the substantially entire bottom portion of the first bag-shaped portion 44 is defined by the first flexible film 52 while the substantially entire bottom portion of the second bag-shaped portion 46 is defined by the second flexible film 54.

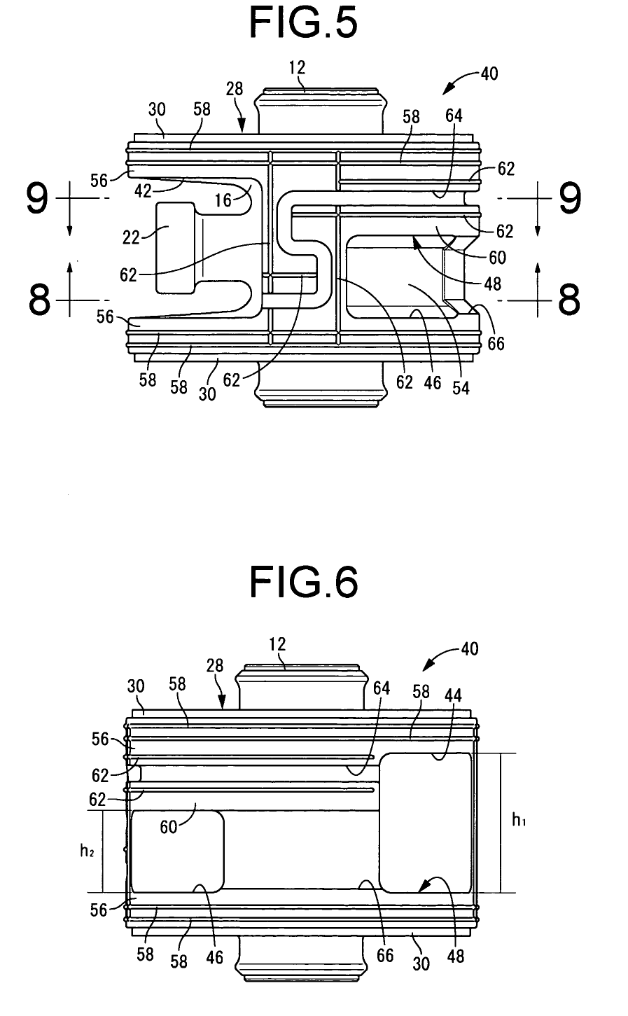

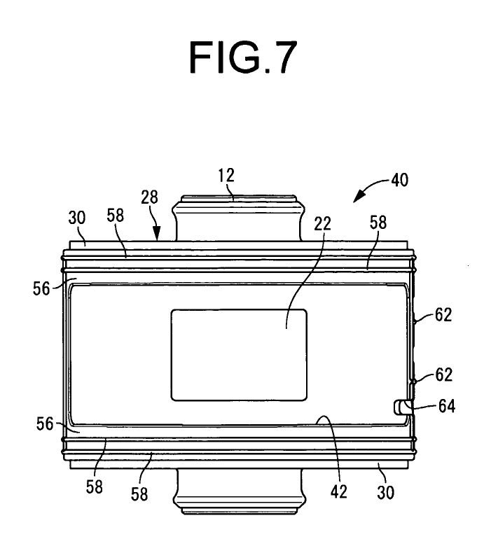

Annular sealing portions 56 are provided on the outer circumferential surface of the large-diameter tubular portion 30 of the intermediate sleeve 28. The annular sealing portions 56 are rubber layers that are integrally formed with the rubber elastic body 16 and as depicted in FIGS. 5 through 7, there are integrally formed seal lips 58 at the outer circumferential surface of the annular sealing portions 56. The seal lips 58 are formed with a generally semi-circular shaped cross section that is convex towards the outer circumferential side and extends continuously over the entire circumference. In the present embodiment, two seal lips 58 are provided with a prescribed separation distance in the axial direction at each axial end portion of the intermediate sleeve 28.

A passage forming rubber 60 is provided on the outer circumferential surface of the small-diameter tubular portion 32 of the intermediate sleeve 28. The passage forming rubber 60 is integrally formed with the rubber elastic body 16 and the annular sealing portions 56, and the outer circumferential surface of the passage forming rubber 60 is situated on substantially the same round tube face as the outer circumferential surface of the annular sealing portions 56.

On the outer circumferential face of the passage forming rubber 60, seal ribs 62 are integrally formed with the seal lips 58 and project out extending along with a circumferential groove 64 (discussed later) in the circumferential and/or axial direction. In the present embodiment, both of the annular sealing portions 56 and the passage forming rubber 60 are integrally formed with the rubber elastic body 16. The seal lips 58 and the seal ribs 62 are also integrally formed therewith.

Here, the passage forming rubber 60 is provided at a portion that does not overlap the second window 36a while partially projecting over one axial end of the second window 36b. Specifically, as depicted in FIGS. 5 and 6, the passage forming rubber 60 partially projects from the axial upper side towards the axial lower side of the second window 36b and extends over the axial upper end of the second window 36b in the circumferential direction. In other words, the passage forming rubber 60 lies solely at the part that projects over the second window 36b, being apart from the intermediate sleeve 28. With this arrangement, as depicted in FIG. 6, the first bag-shaped portion 44 that opens to the outside via the second window 36a and situated at a side of opening of an orifice passage 72 (discussed later) has the axial inside dimension: h₁ greater than the axial inside dimension: h₂ of the second bag-shaped portion 46 that opens to the outside via the second window 36b and situated at a side of the orifice-passage-72-formation part (h₁>h₂). In the present embodiment, the axial inside dimension of the first pocket 42 is set substantially identical to the axial inside dimension: h₁ of the first bag-shaped portion 44.

Moreover, since the axial inside dimension of the first bag-shaped portion 44 is made different from the axial inside dimension of the second bag-shaped portion 46, the first flexible film 52 that partially defines the first bag-shaped portion 44 has the axial dimension greater than the axial dimension of the second flexible film 54 that partially defines the second bag-shaped portion 46. Additionally, the first and second flexible films 52, 54 have the thickness dimensions substantially equal to each other. Thus, the spring constant of the first flexible film 52 in the thickness direction is smaller than the spring constant of the second flexible film 54 in the thickness direction, whereby the first flexible film 52 deforms more readily than the second flexible film 54. It is possible to set a greater difference between the spring constants of the first and second flexible films 52, 54 by setting the thickness dimension of the first flexible film 52 smaller than that of the second flexible film 54.

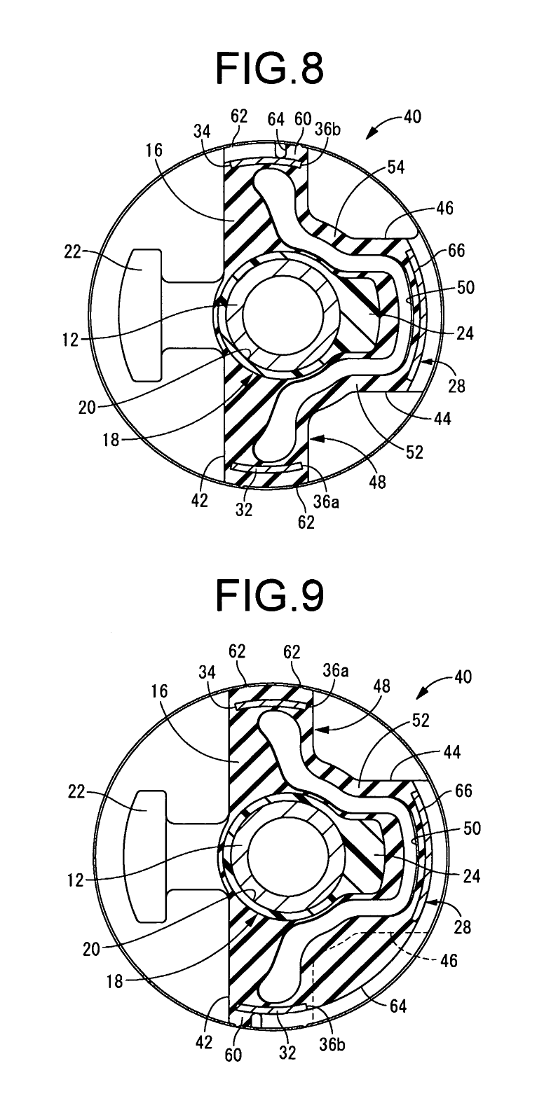

As depicted in FIG. 5 for example, a circumferential groove 64 is formed in the passage forming rubber 60. The circumferential groove 64 is a recessed groove that opens in the outer circumferential surface of the passage forming rubber 60 and extends for a prescribed length just short of halfway around the circumference. As depicted in FIGS. 5 through 9, one of opposite ends of the circumferential groove 64 opens in the circumferential end face of the first pocket 42 while the other of opposite ends thereof opens in the circumferential end face of the first bag-shaped portion 44, whereby the circumferential groove 64 connects the first pocket 42 and the first bag-shaped portion 44 with each other. Furthermore, in the present embodiment, the circumferential groove 64 is arranged such that the vicinity of the first pocket 42-side end thereof extends in the axial direction in a serpentine configuration, whereby a sufficient length of the circumferential groove 64 is ensured.

Additionally, as depicted in FIGS. 5 and 6, the lengthwise medial portion of the circumferential groove 64 is formed in the section where the passage forming rubber 60 projects over the second window 36b and extends in the circumferential direction while being axially above and apart from the second bag-shaped portion 46. With this arrangement, as depicted in FIG. 9, the circumferential groove 64 is formed so as to extend in the circumferential direction axially between the axial end of the second bag-shaped portion 46 and the annular sealing portion 56 and straddle the second window 36b in the circumferential direction, ensuring a sufficient length dimension.

The passage forming rubber 60 further includes a communicating groove 66 in the section located circumferentially between the second window 36a and the second window 36b. As depicted in FIG. 6, the communicating groove 66 opens in the outer circumferential surface of the passage forming rubber 60 and extends in the lower end section thereof in the circumferential direction, with its one circumferential end connected with the first bag-shaped portion 44 while the other end connected with the second bag-shaped portion 46. In the present embodiment, the communicating groove 66 has the widthwise dimension equivalent to approximately ½ of the axial dimension of the passage forming rubber 60 and is formed axially spaced apart from the circumferential groove 64 by a prescribed distance.

The outer tube member 14 is attached to the integrally vulcanization molded component 40 of this construction. Like the inner shaft member 12, the outer tube member 14 is a high-rigidity member made of metal and has a thin, large-diameter, generally round tube shape. The outer tube member 14 is fitted externally onto the integrally vulcanization molded component 40 and then is subjected to a diameter reduction process such as 360-degree radial compression in order to be fastened fitting with the integrally vulcanization molded component 40. In addition, the outer tube member 14 is adapted to be mounted onto the vehicle body side via a bracket (not shown). Moreover, the outer tube member 14 is outwardly fitted onto the large-diameter tubular portion 30 of the intermediate sleeve 28 via the annular sealing portions 56, whereby the annular sealing portions 56 provide a fluid-tight sealing between superposed surfaces between the outer tube member 14 and the large-diameter tubular portion 30. In the present embodiment in particular, with the seal lips 58 compressed between the outer tube member 14 and the large-diameter tubular portion 30 of the intermediate sleeve 28, improved sealing capabilities can be obtained.

By mounting the outer tube member 14 onto the integrally vulcanization molded component 40, the first window 34 is sealed off by the outer tube member 14 so that the opening of the first pocket 42 is closed by the outer tube member 14. With this arrangement, there is formed a pressure receiving chamber 68 utilizing the first pocket 42 whose wall is partially defined by the rubber elastic body 16 and that gives rise to pressure fluctuations at times of vibration input.

Additionally, the first stopper portion 22 of the stopper member 18 that is attached to the inner shaft member 12 projects out within the pressure receiving chamber 68, with its diametrically distal end face opposed to the outer tube member 14 with a given spacing therebetween. Meanwhile, on the opposite side of the first stopper portion 22 with the inner shaft member 12 being interposed therebetween, the second stopper portion 24 is opposed to the intermediate sleeve 28 with a given spacing therebetween. With this arrangement, relative displacement of the inner shaft member 12 and the outer tube member 14 in one diametrical direction (the sideways direction in FIG. 2) is limited by means of abutment of the stopper member 18 against the outer tube member 14 and the intermediate sleeve 28.

Meanwhile, the pair of the second windows 36a, 36b are sealed off by the outer tube member 14 so that the openings of the first and second bag-shaped portions 44, 46 are both covered by the outer tube member 14. With this arrangement, there is formed an equilibrium chamber 70 utilizing the first and second bag-shaped portions 44, 46 whose wall is partially defined by the first and second flexible films 52, 54 and that readily permits change in volume. In the present embodiment, the opening of the communicating groove 66 is covered by the outer tube member 14, thereby forming a communicating passage through which the first and second bag-shaped portions 44, 46 are connected with each other. The first and second bag-shaped portions 44, 46 are arranged to form the one equilibrium chamber 70 in cooperation with each other.

A non-compressible fluid is sealed within the pressure receiving chamber 68 and the equilibrium chamber 70. No particular limitation is imposed on the non-compressible fluid filling the two chambers; water, an alkylene glycol, polyalkylene glycol, silicone oil, or a mixture of these may be favorably employed, for example. In terms of effectively achieving vibration damping effect based on flow action of the fluid (discussed later), it is especially preferable to use a low-viscosity fluid of 0.1 Pa·s or less as the sealed fluid. Sealing of the non-compressible fluid within the pressure receiving chamber 68 and the equilibrium chamber 70 may be easily accomplished by carrying out assembly of the outer tube member 14 to the integrally vulcanization molded component 40 while these components are immersed in a tank filled with the non-compressible fluid.

Furthermore, the outer tube member 14 closes the opening of the circumferential groove 64 fluid-tightly thereby forming an orifice passage 72 that connects the pressure receiving chamber 68 and the equilibrium chamber 70 with each other. The orifice passage 72 is arranged such that one of opposite ends thereof opens in the circumferential end face of the pressure receiving chamber 68 while the other of opposite ends thereof opens in the circumferential end face of the first bag-shaped portion 44 that defines the equilibrium chamber 70. In the present embodiment, the tuning frequency of the orifice passage 72, which is adjusted based on the ratio (A/L) of passage length (L) to passage area (A) thereof, has been set to a low frequency of around 10 Hz that corresponds to engine shake.

With the engine mount 10 of this construction according to the present embodiment installed in an automobile, during input of low-frequency vibration that corresponds to engine shake in one diametrical direction (the sideways direction in FIG. 2) between the inner shaft member 12 and the outer tube member 14, relative pressure fluctuations will be produced between the pressure receiving chamber 68 and the equilibrium chamber 70. Consequently, fluid flow will take place between the pressure receiving chamber 68 and the equilibrium chamber 70 through the orifice passage 72, thereby exhibiting desired vibration damping effect (high attenuating or damping action) on the basis of the resonance action or other flow action of the fluid.

At this point, in the engine mount 10 according to the present embodiment, the orifice passage 72 extends out from the pressure receiving chamber 68 towards the second bag-shaped portion 46 side, keeps on extending in the circumferential direction in the section being axially above and apart from the second bag-shaped portion 46, and is connected to the first bag-shaped portion 44 situated on the opposite side of the pressure receiving chamber 68 with the second bag-shaped portion 46 being interposed therebetween in the circumferential direction. Therefore, it is possible to provide a sufficient passage length of the orifice passage 72, thereby advantageously ensuring the degree of freedom in tuning of the orifice passage 72 to the lower-frequency side. In the present embodiment in particular, the orifice passage 72 is arranged such that the vicinity of pressure receiving chamber 68-side end thereof extends in the axial direction in a serpentine configuration, making it possible to provide even more sufficient length dimension of the orifice passage 72.

In addition, since the orifice passage 72 is connected to the first bag-shaped portion 44 having an expanded axial dimension in comparison with the second bag-shaped portion 46, connection area of the orifice passage 72 to the equilibrium chamber 70 has a sufficient volume while the first flexible film 52 that defines the wall of the connection area has a sufficient area. With this arrangement, the initial pressure exerted on the equilibrium chamber 70 due to the fluid flow through the orifice passage 72 will be effectively absorbed by volume change of the equilibrium chamber 70 based on deformation of the first flexible film 52. As a result, relative pressure fluctuations between the pressure receiving chamber 68 and the equilibrium chamber 70 will be efficiently produced, thereby effectively achieving vibration damping effect exhibited by the fluid flow through the orifice passage 72.

Moreover, whereas the axially expanded first bag-shaped portion 44 ensures a sufficient volume of the connection area in the equilibrium chamber 70 on which the initial pressure will act, the second bag-shaped portion 46 that communicates with the first bag-shaped portion 44 and integrally defines the equilibrium chamber 70 ensures a sufficient volume of the entire equilibrium chamber 70. Additionally, the entire area of the flexible film that realizes volume compensation action in the equilibrium chamber 70 is sufficiently provided by the first and second flexible films 52, 54. Therefore, as the amount of fluid flow through the orifice passage 72 increases, the entire equilibrium chamber 70 exhibits volume compensation action on the pressure receiving chamber 68 more effectively, thereby ensuring the amount of fluid flow through the orifice passage 72. As a result, excellent vibration damping effect based on the flow action of the fluid will be more efficiently attained.

Furthermore, the opposite end portions of the orifice passage 72 that extends in the circumferential direction open to the pressure receiving chamber 68 and the equilibrium chamber 70 in the circumferential direction. Accordingly, the fluid will smoothly flow in and out of the two chambers 68, 70, being capable of more efficiently ensuring the amount of fluid flow through the orifice passage 72. As a result, vibration damping effect based on the flow action of the fluid will be more advantageously exhibited.

Also, in the engine mount 10, since the construction of the equilibrium chamber 70 is specifically designed so as to ensure a sufficient passage length of the orifice passage 72, it is possible to obtain a sufficient capacity of the pressure receiving chamber 68 while at the same time providing a sufficient passage length of the orifice passage 72. Therefore, a sufficient effective piston surface area of the pressure receiving chamber 68 can be obtained, making it possible to efficiently induce the fluid flow through the orifice passage 72. Consequently, vibration damping effect based on the flow action of the fluid will be advantageously exhibited, thereby improving vibration damping capabilities.

In addition, since the construction of the equilibrium chamber 70 is specifically designed so as to provide the orifice passage 72 in the axially medial portion of the engine mount 10, it is not necessary to expand axial dimension of the engine mount 10 in order to ensure the passage length of the orifice passage 72. This allows to achieve the engine mount 10 in a compact design that exhibits excellent vibration damping effect against low-frequency vibration input. Moreover, the orifice passage 72 is provided in the passage forming rubber 60 that is integrally formed with the rubber elastic body 16 and bonded by vulcanization to the intermediate sleeve 28. With this arrangement, no orifice forming member is required as a separate element in order to form the orifice passage 72, making it possible to obtain the orifice passage 72, which extends in the axially medial portion, with a small number of parts. As a result, the number of manufacturing process can be reduced, while achieving lower production cost.

Additionally, in the present embodiment, the annular sealing portions 56 and the seal lips 58 that are provided at axially opposite end portions of the intermediate sleeve 28 are able to prevent leakage of non-compressible fluid sealed within the interior to the outside. Moreover, the seal ribs 62 that are integrally formed with the passage forming rubber 60 are able to prevent short circuit of the fluid among the pressure receiving chamber 68, the equilibrium chamber 70 and the orifice passage 72. Accordingly, desired vibration damping capabilities can be surely maintained.

Furthermore, in the present embodiment, the passage forming rubber 60 that includes the orifice passage 72 partially projects over the opening edge of the second window 36b. In this respect, the pair of the second windows 36a, 36b are substantially identical with each other in shape and the intermediate sleeve 28 has a symmetrical construction in the vertical direction. Therefore, when the rubber elastic body 16 is molded by vulcanization, during setting the intermediate sleeve 28 with respect to the mold for vulcanization molding of the rubber elastic body 16, an error in vulcanization due to setting the intermediate sleeve 28 upside down will be prevented, thereby avoiding occurrence of defective products.

While the present invention has been described hereinabove in terms of a preferred embodiment, this is merely exemplary, and the invention shall not be construed as limited in any way to the specific disclosures in the embodiment.

For example, in the preceding embodiment, the second pocket 48 is constituted such that the first bag-shaped portion 44 and the second bag-shaped portion 46, which opens in the outer circumferential surface through mutually independent second window 36a and second window 36b respectively, are held in communication with each other through the communicating groove 66. However, it would also be acceptable for the second pocket, for example, to entirely open in the outer circumferential surface through one window while its substantially entire bottom face being defined by one flexible film. That is to say, the equilibrium chamber need not necessarily have a construction in which a first and second bag-shaped portions are held in communication with each other.

Also, while in the preceding embodiment, a part of the orifice passage 72 is formed in the section of the passage forming rubber 60 that projects over the second window 36b, it would also be possible for example that one second window has a shape corresponding to the opening of the second bag-shaped portion 46 so that the pair of second windows have different shapes from each other. With this arrangement, the orifice passage 72 will have its entire bottom portion affixed by the intermediate sleeve 28, thereby achieving a stable passage shape.

Additionally, whereas the equilibrium chamber 70 in the preceding embodiment has a stepped shape whose axial inside dimension is made larger on the first bag-shaped portion 44 side rather than on the second bag-shaped portion 46 side, the equilibrium chamber may alternatively have a tapered wall that gradually expands in the axial direction from the side of the orifice-passage-72-formation part towards the side of opening of the orifice passage 72.

Moreover, while in the preceding embodiment, the orifice passage 72 is arranged such that the vicinity of pressure receiving chamber 68-side end thereof extends in the axial direction in a serpentine configuration, such serpentine portion may be dispensed with, and instead the entire orifice passage may extend in the circumferential direction at a certain axial level.

Further, in the preceding embodiment, the fluid-filled cylindrical vibration-damping device of construction according to the present invention has been shown reduced to practice in an automotive engine mount by way of example. However, the present invention may also be implemented in fluid-filled cylindrical vibration-damping devices for use in non-automotive applications such as train cars or motorized two wheeled vehicles, for example. Furthermore, the present invention is applicable not just to engine mounts, but also to suspension bushings, body mounts, sub-frame mounts, differential mounts, and the like.

What is claimed is:

1. A fluid-filled cylindrical vibration-damping device comprising:
an inner shaft member;
a tubular intermediate sleeve disposed outward of the inner shaft member with a gap therebetween, and having a first window and at least one second window;
a rubber elastic body elastically connecting the inner shaft member and the intermediate sleeve, the rubber elastic body includes a first pocket and a second pocket provided at respective circumferential portions thereof while opening in an outer circumferential surface of the intermediate sleeve through the first and second windows of the intermediate sleeve, the rubber elastic body being provided with a slit so that a bottom portion of the second pocket is defined as at least one flexible film;
an outer tube member outwardly fitted onto the intermediate sleeve in order to close an opening of the first pocket and define a pressure receiving chamber whose wall is partially defined by the rubber elastic body and filled with a non-compressible fluid, and in order to close an opening of the second pocket and define an equilibrium chamber whose wall is partially defined by the flexible film and filled with the non-compressible fluid; and
an orifice passage permitting a fluid communication between the pressure receiving chamber and the equilibrium chamber,
wherein annular sealing portions are provided at axially opposite end portions between the intermediate sleeve and the outer tube member over entire circumferences thereof,
a circumferential groove is provided at so as to extend in a circumferential direction between at least one of axially opposite edge portions of the second pocket and the annular sealing portion or portions that are opposed in an axial direction to the at least one of axially opposite edge portions of the second pocket, the circumferential groove is closed by means of the outer tube member to provide the orifice passage,
one of opposite ends of the orifice passage opens to the pressure receiving chamber in the circumferential direction, and another of opposite ends of the orifice passage opens to the equilibrium chamber in the circumferential direction such that an axial inside dimension of the second pocket that defines the equilibrium chamber is expanded in comparison with that of an orifice-passage-formation part at a side of opening of the orifice passage.

2. The fluid-filled cylindrical vibration-damping device according to claim 1, wherein the second window of the intermediate sleeve has an axial dimension corresponding to that of an expanded portion of the second pocket over an entire circumferential length thereof, and a part of the second pocket where the circumferential groove is defined is integrally formed with the rubber elastic body, and projects axially inwardly from the one of axially opposite edge portions of the second window.

3. The fluid-filled cylindrical vibration-damping device according to claim 1, wherein the second pocket includes a first bag-shaped portion and a second bag-shaped portion, which are spaced away from each other in the circumferential direction,
wherein the at least one flexible film comprises a first flexible film and a second flexible film which partially define the first bag-shaped portion and the second bag-shaped portion respectively,
wherein a communicating groove is provided for connecting the first and second bag-shaped portions,
wherein an axially inside dimension of the first bag-shaped portion is expanded in comparison with that of the second bag-shaped portion at least one of axially opposite sides to provide the orifice passage between the one of axially opposite edge portions of the second bag-shaped portion and the annular sealing portion in the axial direction, and
wherein the other one of the opposite ends of the orifice passage is connected to the equilibrium chamber at a portion composed of the first bag-shaped portion.

4. The fluid-filled cylindrical vibration-damping device according to claim 3, wherein the first flexible film that partially defines the first bag-shaped portion has an axial dimension greater than an axial dimension of the second flexible film that partially defines the second bag-shaped portion while the first and second flexible films have thickness dimensions substantially equal to each other so that a spring constant of the first flexible film in a thickness direction is smaller than a spring constant of the second flexible film in the thickness direction.

5. The fluid-filled cylindrical vibration-damping device according to claim 4, wherein the at least one second window comprises a pair of second windows, and
wherein the first bag-shaped portion and the second bag-shaped portion are circumferentially connected with each other via the communicating groove formed in a section located between the pair of the second windows in a small-diameter tubular portion of the intermediate sleeve so that an entire equilibrium chamber exhibits volume compensation action on the pressure receiving chamber.

6. The fluid-filled cylindrical vibration-damping device according to claim 1, wherein the orifice passage is arranged such that a vicinity of pressure receiving chamber-side end thereof extends in the axial direction in a serpentine configuration.

7. The fluid-filled cylindrical vibration-damping device according to claim 1, wherein a passage forming rubber is integrally formed with the rubber elastic body on an outer circumferential surface of a small-diameter tubular portion of the intermediate sleeve,
wherein the circumferential groove is formed in the passage forming rubber, and
wherein seal ribs are formed on an outer circumferential face of the passage forming rubber and project out extending along with the circumferential groove in the circumferential and axial direction so that the seal ribs prevent short circuit of the non-compressible fluid among the pressure receiving chamber, the equilibrium chamber and the orifice passage.
